(19) United States
(12) Patent Application Publication
(10) Pub. No.: US 2007/0195799 A1
(43) Pub. Date: Aug. 23, 2007

(54) Packet Routing Method And Packet Routing Apparatus

(75) Inventors: Takeshi Kanazawa, Kanagawa (JP); Naoto Oka, Kanagawa (JP); Toyoki Kawahara, Tokyo (JP); Hirokazu Kobayashi, Kanagawa (JP)

Correspondence Address: STEVENS, DAVIS, MILLER & MOSHER, LLP, 1615 L. STREET N.W., SUITE 850, WASHINGTON, DC, 20036, US

(73) Assignee: Matsushita Electric Industrial Co., Ltd, Osaka (JP)

(21) Appl. No.: 10/589,636

(22) PCT Filed: Feb. 17, 2005
(86) PCT No.: PCT/JP05/02488

§ 371 Date: Oct. 4, 2006

(30) Foreign Application Priority Data
Feb. 19, 2004 (JP) 2004-043563

(51) Int. Cl. H04L 12/56

(52) U.S. Cl. 370/401; 370/351

(57) ABSTRACT

A packet routing method for quickly reorganizing a path from a transmission source terminal to a destination terminal. A radio receiver part (103) detects, from a decrease of the field intensity or the like, a cut-off of a communication with a communication device using a radio signal to directly transmit packets. A control part (105) determines whether the local terminal device including it is the packet destination radio terminal device or the packet transmission source radio terminal device. When it is determined that the communication with a communication device using the radio signal to directly transmit packets is cut off and that the local terminal device is the transmission source radio terminal device, a radio transmitter part (104) broadcasts a request signal of path restoration addressed to the packet destination communication device.

### TECHNICAL FIELD

The present invention relates to a packet routing method and packet routing apparatus, and more particularly, to a packet routing method and packet routing apparatus used in an adhoc network where wireless terminal apparatuses communicate with one another.

### BACKGROUND ART

As conventional technique for performing wireless packet communication on an adhoc network where a plurality of freely moving wireless terminals communicate with one another,there exists the AODV (Adhoc On-demand Distance Vector:RFC3561) routing protocol being standardized by MANET (Mobile Adhoc NETworks) working group of IETF (Internet Engineering Task Force).

On MANET, even when a source terminal as a source of a data packet cannot directly communicate with a destination terminal as a destination of the transmitted data packet due to the relationship of the distance and the like, one or more wireless terminals existing between the source terminal and the destination terminal relay the data packet. It is thereby possible to transfer data from the source terminal to the destination terminal when the transmitting terminal cannot communicate directly with the destination terminal.

For establishing a communication route from the source terminal to destination terminal, there are major two methods in MANET. One is a method by on-demand type routing protocol such as AODV whereby the communication route is established only when a request for communication is made from an application and the like. The other is table driving type routing protocol such as OLSR (Optimized Link State Routing:RFC3626) whereby packets are transmitted to all terminals at regular intervals to establish (update) routes, like a routing protocol in wired networks.

The on-demand type routing protocol performs a route search per data transmission and therefore have high transmission cost each time. However, the protocol does not consume a communication band regularly, and therefore has a little influence on other terminals and low power consumption. Meanwhile, the table driving type routing protocol establishes routes in advance, so that the protocol has advantages when the terminals transmit data frequently. However, the protocol consumes a communication band regularly for the route establishment (update), and is therefore highly likely to influence other terminals in transmitting data when sharing a wireless medium.

In view of the forgoing, when an adhoc network is established using terminals driven by batteries, the on-demand type routing protocol is generally used.

Such a technique is known that enables communications between a source terminal and destination terminal using the on-demand type routing protocol even when many fixed relay terminals do not exist between the source terminal and destination terminal (for example, see Patent Document 1).

The technique disclosed in Patent Document 1 will be described below using FIGS. 1 to 4. In FIGS. 1 to 4, it is assumed that a wireless terminal as a source of data is source terminal 21, another wireless terminal that receives the data finally is destination terminal 22, and wireless terminals that relay the data are relay terminals 11 to 20. Source terminal 21, destination terminal 22 and relay terminals 11 to 20 are movable terminals.

As shown in FIG. 1, source terminal 21 transmits data to destination terminal 22 via relay terminals 12, 13, 16 and 19 on a first communication route established by some method. Herein, since wireless terminals 11 to 22 are movable, for example, as shown in FIG. 2, it is assumed that the distance between relay terminals 16 and 19 becomes greater and communication disconnection occurs. Relay terminal 19 detects disconnection of communication with relay terminal 16 based on the radio wave state and the like, and transmits communication disconnection report data P1 to destination terminal 22.

Upon receiving communication disconnection report data P1, destination terminal 22 broadcasts control data for route establishment (hereinafter, referred to as “routing data”) P2 as shown in FIG. 3 to reestablish the route to source terminal 21. Relay terminals 19 and 20 receiving the routing data P2 broadcast the routing data P2 similarly. However, a broadcast packet once received is not retransmitted. By performing broadcast transmission sequentially by the relay terminals, routing data P2 reaches source terminal 21, and a second communication route is thereby established via relay terminals 19, 18, 15 and 12.

At this point, relay terminals 19, 18, 15 and 12 store identifiers of the terminals in the routing data P2 sequentially, so that the second communication route from source terminal 21 to destination terminal 22 can be established.

Alternatively, relay terminals 19, 18, 15 and 12 and source terminal 21 store the correspondence between destination terminal 22 as a source transmitting the routing data P2 and a terminal as a previous hop transmitting the routing data P2, so that it is possible to establish the second communication route from source terminal 21 to destination terminal 22. As a specific example of this case, relay terminal 19 stores the correspondence between destination terminal 22 as the source and destination terminal 22 as the previous hop, and relay terminal 18 stores the correspondence between destination terminal 22 as the source and relay terminal 19 as the previous hop.

By thus establishing the second communication route, as shown in FIG. 4, source terminal 21 can transmit data again to destination terminal 22. Patent Document 1: Japanese Patent Application Laid-Open No. H11-239176

### DISCLOSURE OF INVENTION

Problems to be Solved by the Invention

However, there are following problems in the above-mentioned packet routing method. That is, a relay terminal relaying data between a source terminal and another relay terminal on the source terminal side detecting communication disconnection, and the source terminal cannot recognize the communication disconnection until receiving the routing data, and continue data transmission until recognizing the communication disconnection. The relay terminal on the source terminal side detecting the communication disconnection consequently continues buffering the data, and, when the relay terminal is out of the reestablished route, the relay terminal has to discard the buffered data.

It is therefore an object of the present invention to provide a packet routing method and packet routing apparatus capable of reestablishing the route immediately without wasting data packets buffered in a relay terminal detecting communication disconnection when a route from a source terminal to a destination terminal is reestablished on a network.

Means for Solving the Problem

A packet routing apparatus of the present invention for establishing a route for packet transmission and transmitting packets from a source apparatus to a destination apparatus by radio signals using a plurality of apparatuses, the packet routing apparatus employing a configuration having: a reception section that receives a radio signal containing packets and detects that communication with a communication apparatus directly transmitting the packets using radio signals, is disconnected; a control section that determines whether the packet routing apparatus is located on a side of a destination wireless terminal apparatus or a side of a source wireless terminal apparatus of the packets; and a transmission section that broadcasts a request signal for route repair to a destination communication apparatus of the packets when communication with the communication apparatus directly transmitting the packets using radio signals is determined to be disconnected and the packet routing apparatus is determined to be located on the side of the source wireless terminal apparatus.

According to this configuration, a relay terminal detecting route disconnection makes requests for both route repair and transmission of a route search packet to a destination terminal, so that the relay terminal can repair the route to the destination terminal immediately without wasting data packets for the destination terminal stored in the relay terminal detecting the route disconnection and reduce the time required to establish an optimal route from a source terminal to the destination terminal.

Advantageous Effect of the Invention

According to the present invention, when a route from a source terminal to a destination terminal is reestablished on a network, it is possible to reestablish the route immediately without wasting data packets buffered in a relay terminal detecting communication disconnection.

### BRIEF DESCRIPTION OF DRAWINGS

FIG. 1 is a view of a network using conventional wireless adhoc terminals;

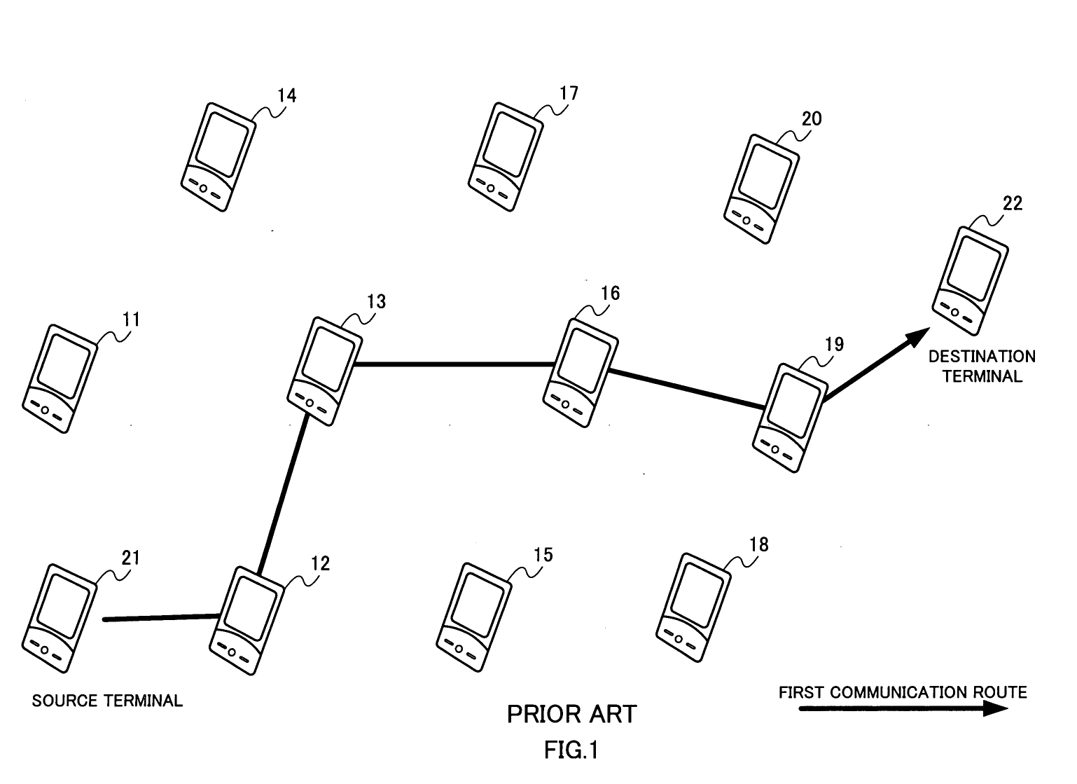

FIG. 2 is another view of the network using conventional wireless adhoc terminals;

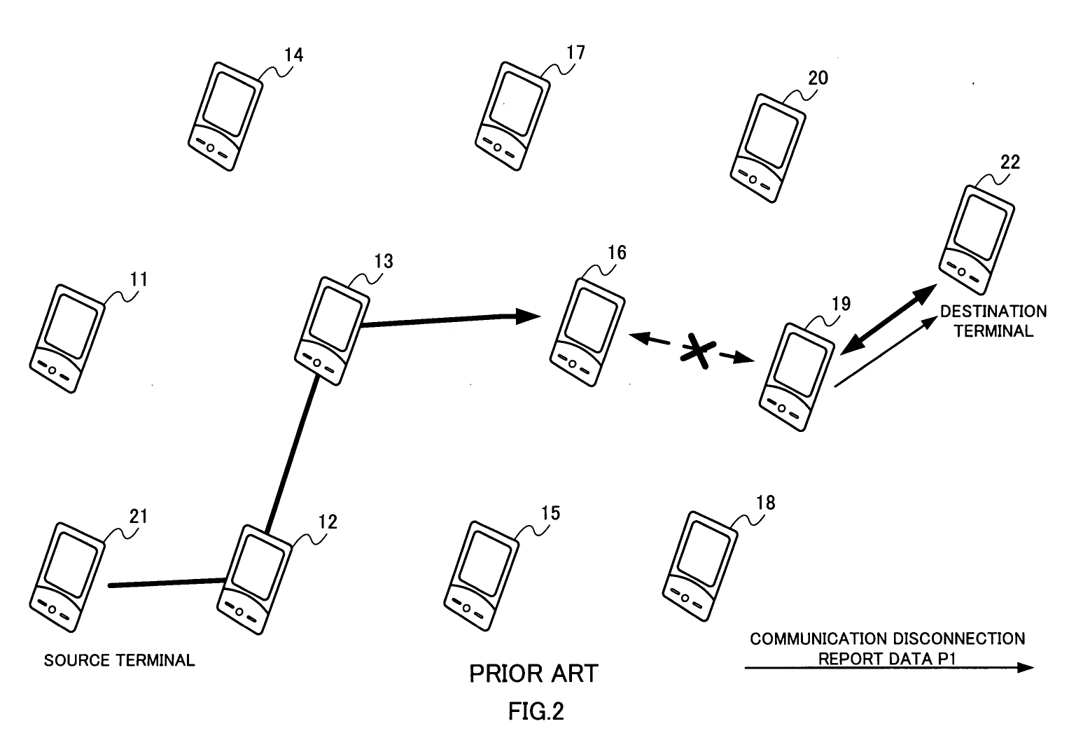

FIG. 3 is another view of the network using conventional wireless adhoc terminals;

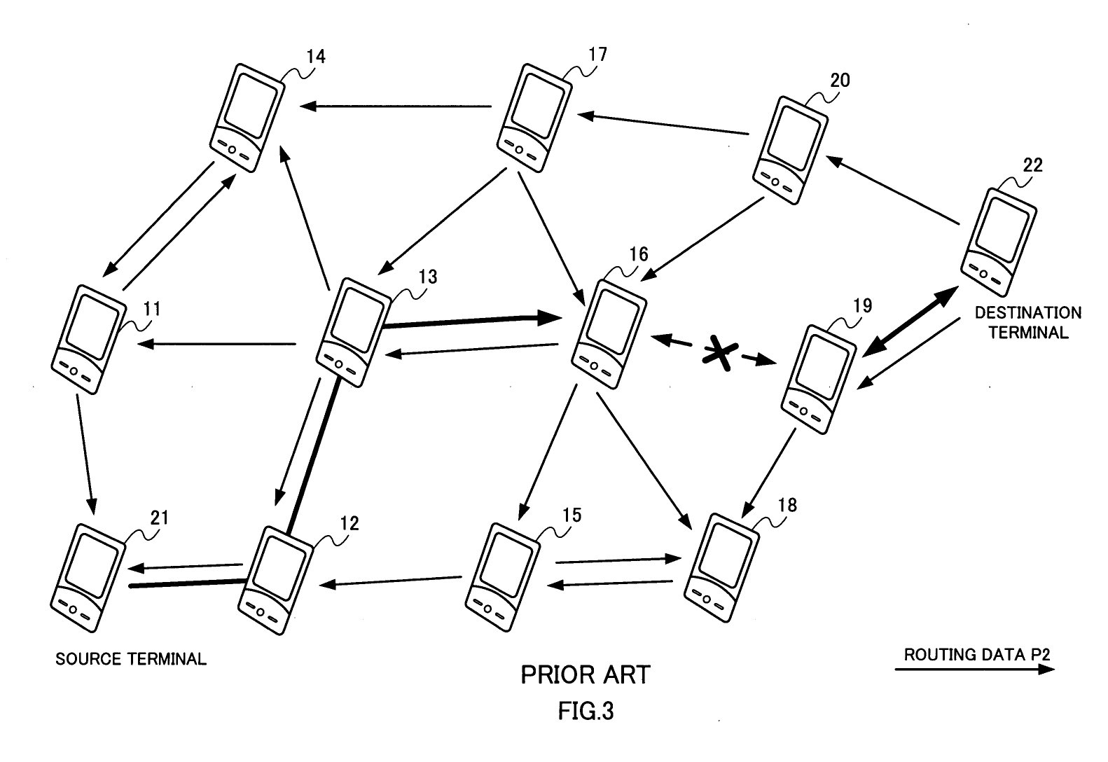

FIG. 4 is still another view of the network using conventional wireless adhoc terminals;

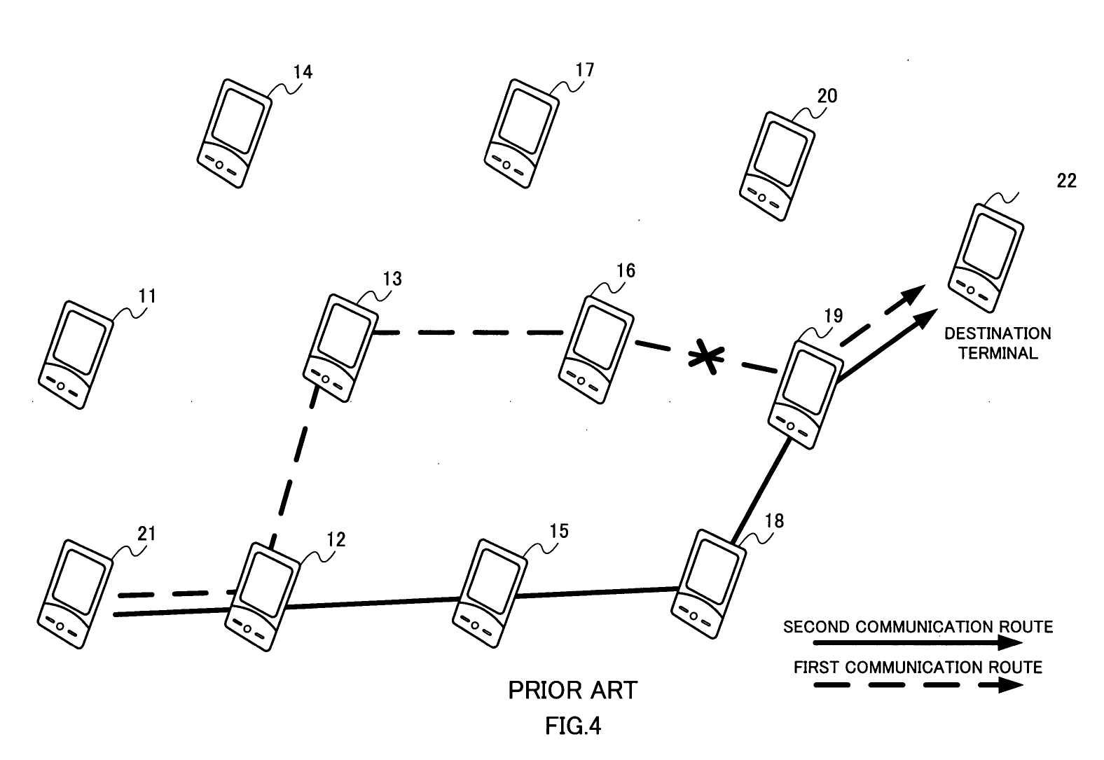

FIG. 5 is a block diagram illustrating a configuration of a wireless adhoc terminal according to one embodiment of the present invention;

FIG. 6 is a flow chart illustrating control processing of the wireless adhoc terminal as shown in FIG. 5;

FIG. 7 is a view of a network using the wireless adhoc terminal as shown in FIG. 5;

FIG. 8 is another view of the network using the wireless adhoc terminal as shown in FIG. 5;

FIG. 9 is a flow chart illustrating detailed procedures of reception processing of a route search packet as shown in FIG. 6;

FIG. 10 is another view of the network using the wireless adhoc terminal as shown in FIG. 5;

FIG. 11 is a flow chart illustrating detailed procedures of reception processing of a route response packet as shown in FIG. 6;

FIG. 12 is another view of the network using the wireless adhoc terminal as shown in FIG. 5;

FIG. 13 is a flow chart illustrating detailed procedures of reception processing of a data transmission packet as shown in FIG. 6; and

FIG. 14 is a flow chart illustrating detailed procedures of reception processing of a data relay packet as shown in FIG. 6.

### BEST MODE FOR CARRYING OUT THE INVENTION

An embodiment of the present invention will be described below in detail with reference to the accompanying drawings.

### ONE EMBODIMENT

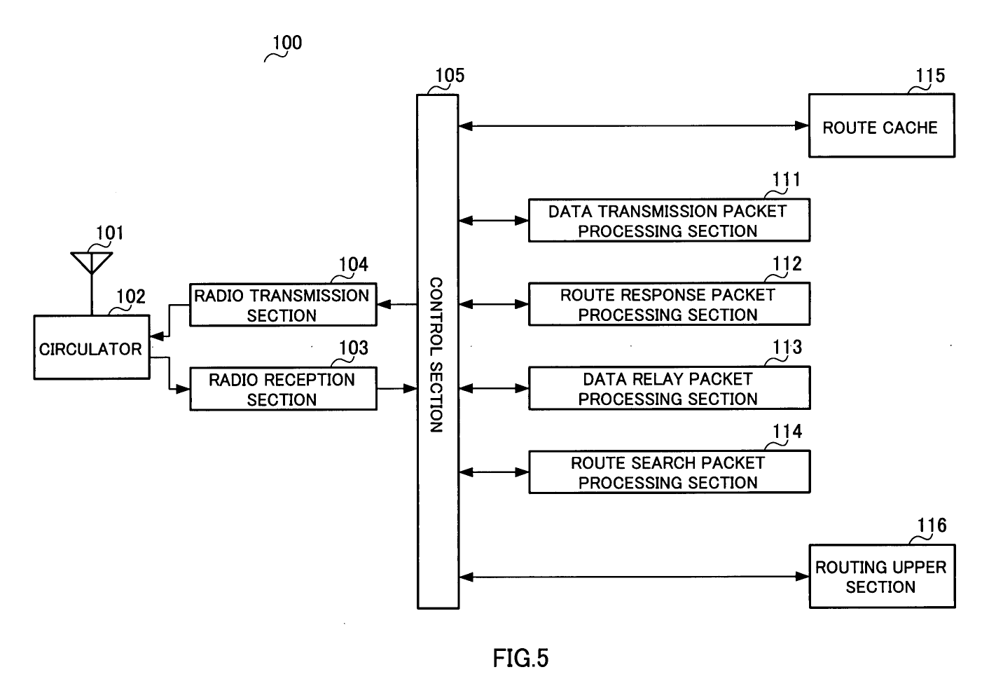

FIG. 5 is a block diagram illustrating a configuration of a wireless adhoc terminal (hereinafter, simply referred to as a “terminal”) according to one embodiment of the present invention. In this figure, a radio signal including packet data received in transmission/reception antenna 101 is input to radio reception section 103 via circulator 102. A signal output from radio transmission section 104 is transmitted from transmission/reception antenna 101 via circulator 102.

Radio reception section 103 demodulates the radio signal input from circulator 102, and outputs the demodulated signal to control section 105. Further, radio reception section 103 monitors the electric field strength and the like of the input radio signal, and when a decrease in electric field strength is detected, determines that communication with a terminal which directly transmits the packet is disconnected. Radio reception section 103 reports the detection of the disconnection of the communication to control section 105.

Control section 105 performs various processing on the signal output from radio reception section 103, and when the detection of the communication disconnection is reported from radio reception section 103, determines whether the terminal is located on the side of a wireless terminal apparatus as a destination of the packet (hereinafter, referred to as a “destination terminal,” or on the side of a terminal as a source (hereinafter referred to as a “source terminal”).

Radio transmission section 104 modulates a signal output from control section 105, and outputs the modulated signal to circulator 102. Further, when communication disconnection with a terminal which directly transmits a packet is determined to be on the source terminal side in control section 105, radio transmission section 104 broadcasts a request signal for repairing the route to the destination terminal.

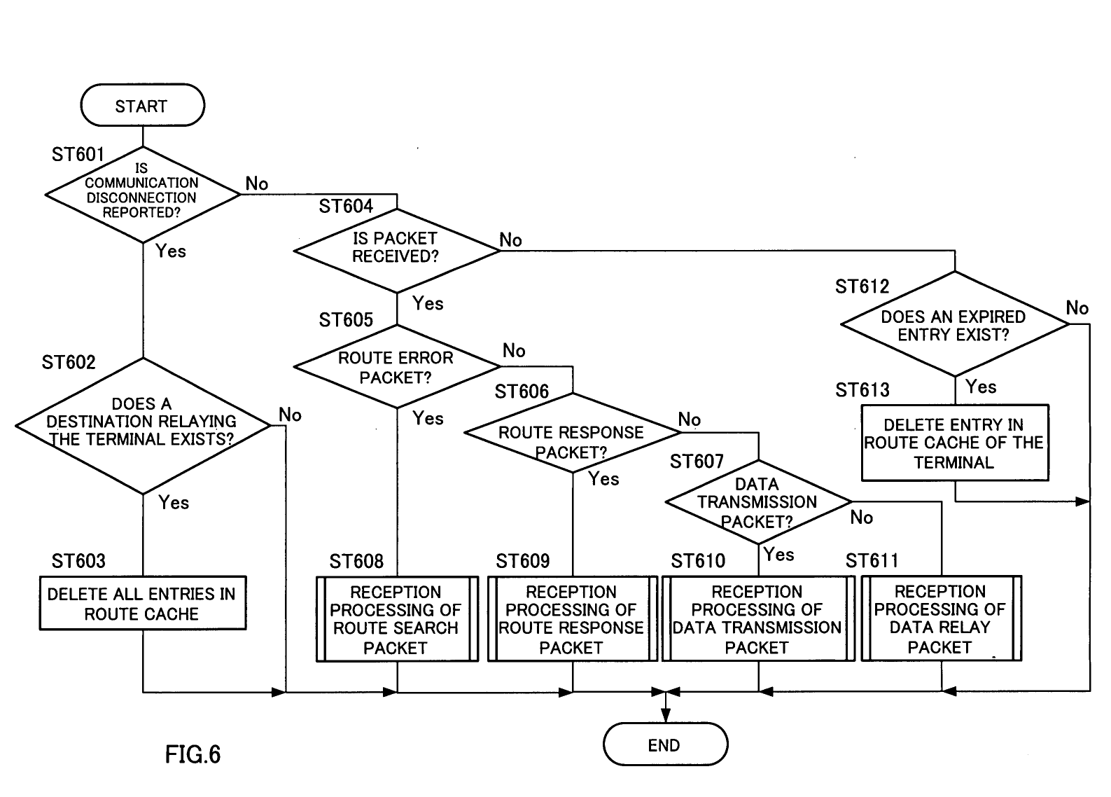

Control processing of the wireless adhoc terminal having the above-mentioned configuration will be described below using FIG. 6. In FIG. 6, in step (hereinafter, referred to as “ST”) 601, whether or not control section 105 receives a report of communication disconnection from radio reception section 103 is determined, and when the report of communication disconnection is determined received (“Yes”), the processing shifts to ST602, and when the report of communication disconnection is determined not received (“No”), the processing shifts to ST604.

In ST602, whether or not identification information of the communicating party terminal with which communication is disconnected and the destination terminal to which the subject terminal directly transmit packets, exists in route cache 115 is searched, and, when the identification information of the communicating party terminal exists (“Yes”), the processing shifts to ST603, and when the identification information of the communicating party terminal does not exist (“No”) control processing is completed.

In ST603, all entries corresponding to the searched destination terminal existing in route cache 115 in ST602 are deleted, and the control processing is completed.

In ST604, control section 105 determines whether or not a packet is received from radio reception section 103, and when the packet is received (“Yes”), the processing shifts to processing of ST605, and when the packet is not received (“No”), the processing shifts to ST612.

In ST605, control section 105 determines whether or not the received packet is a route search packet, and when the packet is a route search packet (“Yes”), the processing shifts to ST608, and when the packet is not a route search packet (“No”), the processing shifts to ST606.

In ST606, control section 105 determines whether or not the received packet is a route response packet, and when the packet is a route response packet (“Yes”), the processing shifts to ST609, and when the packet is not a route response packet (“No”), the processing shifts to ST607.

In ST607, control section 105 determines whether or not the received packet is a data transmission packet, and when the packet is a data transmission packet (“Yes”) the processing shifts to ST610, and when the packet is not a data transmission packet (“No”), the processing shifts to ST611.

In ST608, route search packet processing section 114 performs reception processing of the route search packet, and finishes the control processing.

In ST609, route response packet processing section 112 performs reception processing of the route response packet, and finishes the control processing.

In ST610, data transmission packet processing section 111 performs reception processing of the data transmission packet, and finishes the control processing.

In ST611, data relay packet processing section 113 performs reception processing of a data relay packet, and finishes the control processing.

The reception processing of the route search packet in ST608, the reception processing of the route response packet in ST609, the reception processing of the data transmission packet in ST610, and the reception processing of the data relay packet in ST611 will be described in detail later.

In ST612, control section 105 searches for an expired entry in route cache 115, and when an expired entry exists (“Yes”), control section 105 deletes the entry from route cache 115 in ST613 and finishes the control processing. When an expired entry does not exist (“No”), control section 105 finishes the control processing.

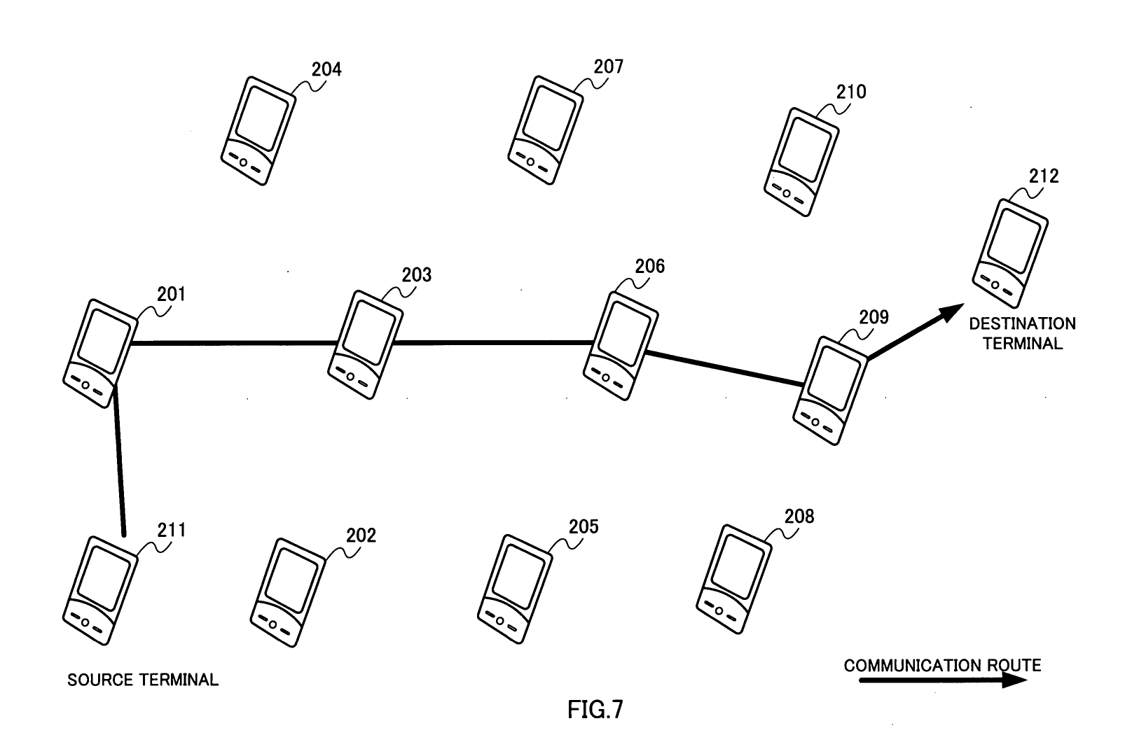

Here, a network using the above-mentioned wireless adhoc terminal is illustrated in FIG. 7, and a case will be described where data packets are transmitted from source terminal 211 to destination terminal 212 via relay terminals 201, 203, 206 and 209. At this point, as information for each terminal to hold, source terminal 211 holds terminal identification information to identify a terminal to which source terminal directly performs transmission (here, terminal identification information of relay terminal 201), and relay terminals 201, 203, 206 and 209 hold terminal identification information of subsequent terminals to destination terminal 212.

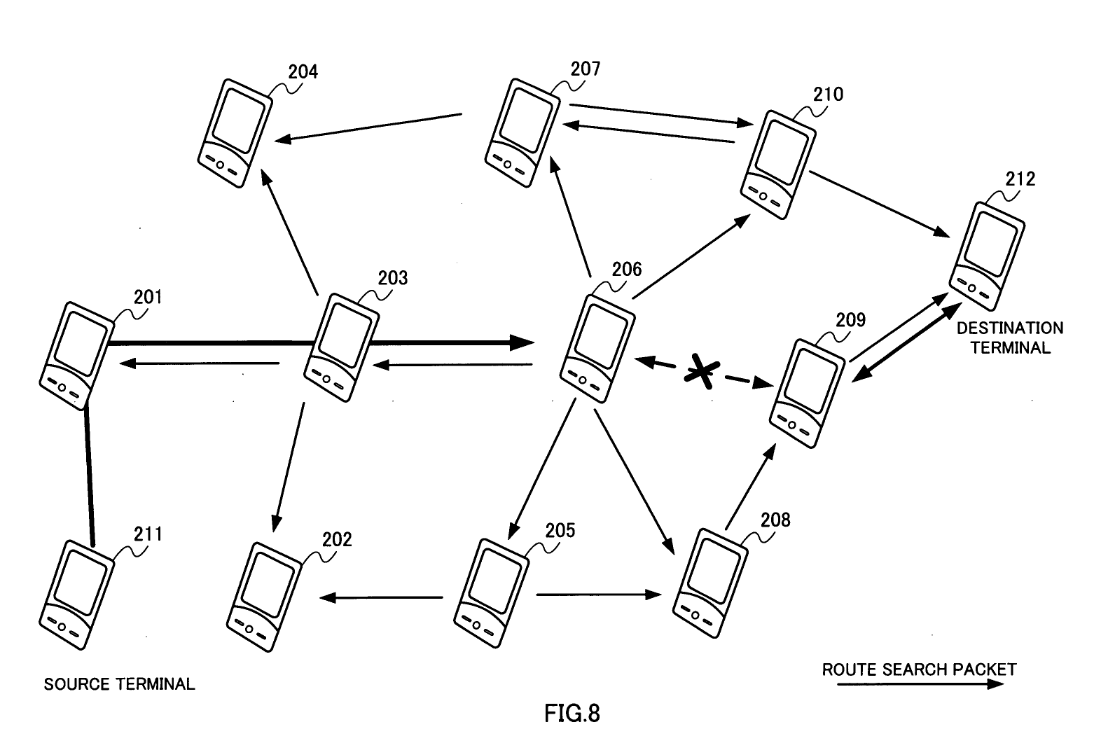

Then, during transmission of data packets, when the distance between relay terminals 206 and 209 becomes greater as shown in FIG. 8, radio reception section 103 in relay terminal 206 detects a decrease in electric field strength of relay terminal 209, and reports communication disconnection with relay terminal 209 to control section 105. The operations of relay terminal 206 will be mainly described below.

Control section 105 receiving the report of the communication disconnection (ST601) searches whether or not the identification information of destination terminal 212 to which reported relay terminal 209 directly performs transmission exists in route cache 115 in terminal 206 (ST602). When the identification information of the corresponding destination terminal exists, control section 105 deletes all the entries corresponding to the corresponding destination terminal (ST603).

As shown in FIG. 8, a route search packet to destination terminal 212 transmitted from relay terminal 206 is received in by relay terminals 203, 205, 207, 208 and 210 that are neighboring terminals of relay terminal 206. Among the terminals, when the received packet is determined to be a route search packet by packet type determination (ST605) in relay terminal 210 as an neighboring terminal of destination terminal 212, the reception processing of the route search packet is performed (ST608) in route search packet processing section 114 in relay terminal 210.

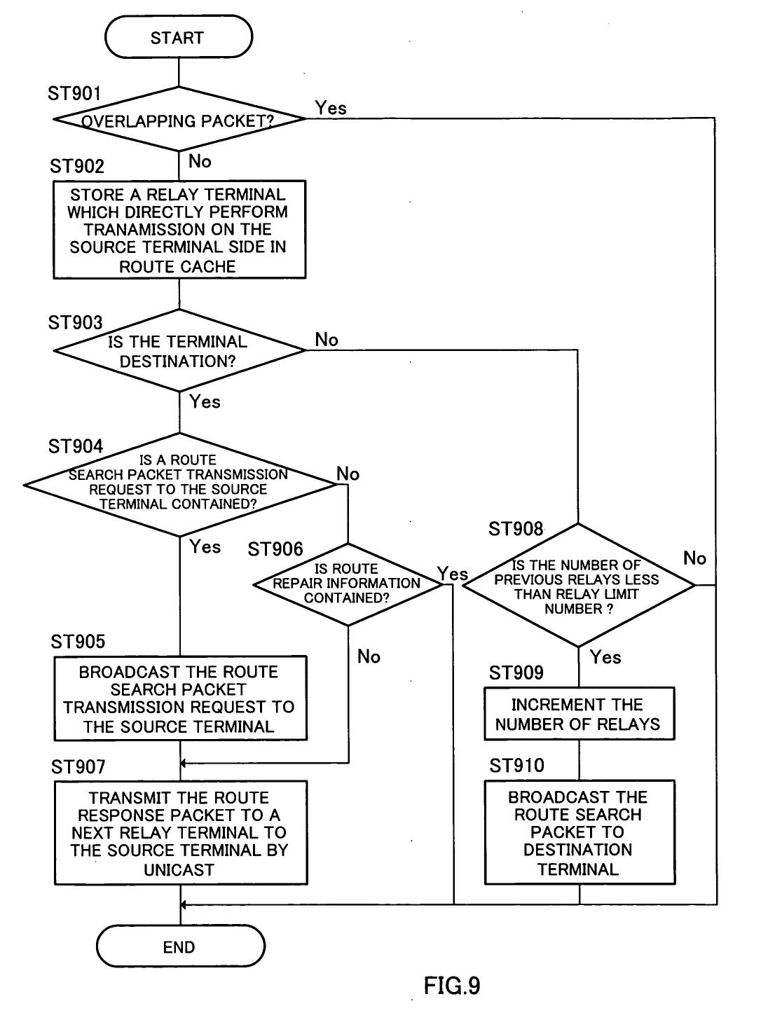

Next, detailed procedures of the reception processing of the route search packet shown in ST608 in FIG. 6 will be described using FIG. 9. In FIG. 9, whether or not the received route search packet is the same as an already received packet (overlapping packet) is determined, and when the received packet is determined to be an overlapping packet (“Yes”), the reception processing of the route search packet is completed, and when the received packet is determined not to be an overlapping packet (“No”), the processing shifts to ST902.

The route search packet is propagated by broadcast, so that, for example, as shown in FIG. 8, when relay terminal 207 receives the route search packet transmitted from relay terminal 206 and further transfers the packet by broadcast, this route search packet also reaches relay terminal 210. However, relay terminal 210 has already received the same route search packet from relay terminal 206, and therefore, in ST901, processing of such an overlapping packet is prevented.

In ST902, in order to establish route to a source terminal for the route search packet, relay terminal 210 stores relay terminal 206 in route cache 115 as a terminal on the source terminal 211 side (it is relay terminal 206 that actually transmits the route search packet, but the content of the packet pretends to be transmitted from source terminal 211) which directly transmits data.

In ST903, whether or not the destination of the route search packet is the terminal, and when the destination is determined to be the terminal (“Yes”), the processing shifts to ST904, and, when the destination is determined not to be the terminal (“No”), the processing shifts to ST908.

When the destination terminal is determined to be the terminal in ST903, corresponding to a case where destination terminal 212 receives the route search packet, in ST904, destination terminal 212 determines whether or not the route search packet contains a route search packet transmission request to source terminal 211. When the packet contains a route search packet transmission request (“Yes”), the processing shifts to ST905, and when the packet does not contain a route search packet transmission request (“No”), the processing shifts to ST907.

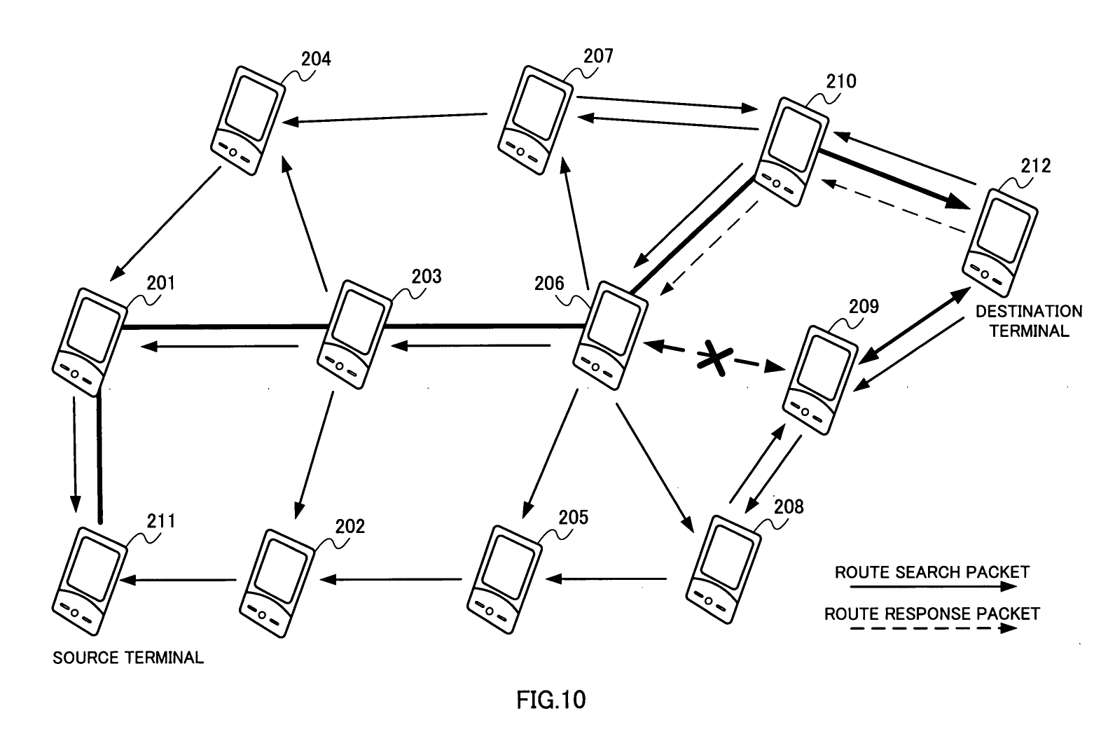

In ST905, terminal 212 broadcasts a route search packet (including route repair information indicating that the route search packet is for repair of the route to source terminal 211) to source terminal 211 as the source of the route search packet (corresponding to the thin solid line in FIG. 10).

In ST906, the terminal determines whether or not the route search packet contains the route repair information, and when the packet contains the route repair information (“Yes”), the reception processing of the route search packet is completed since the operation for the route repair is already performed in ST902, and when the packet does not contain the route repair information (“No”), the processing shifts to ST907.

In ST907, destination terminal 212 transmits a route response packet to the relay terminal to which destination terminal 212 directly performs transmission (the relay terminal which transmits route search packet to the terminal 212: here, relay terminal 210) on the source terminal 211 side by unicast (corresponding to the dashed line in FIG. 10), and finishes the reception processing of the route search packet.

When, in ST903, the destination terminal is determined not to be the terminal, the terminal compares the number of times the route search packet is already relayed with the relay limit number, which is set for this route search packet so as to prevent the packet from being relayed endlessly. When the number of times the packet is already relayed is less than the relay limit number (“Yes”), the processing shifts to ST909, and when the number of times the packet is already relayed is equal to or greater than the relay limit number (“No”), the reception processing of the route search packet is completed without relaying since the route search packet cannot be propagated.

The terminal increments the number of relays in ST909, broadcasts the route search packet again to neighboring terminals, and finishes the reception processing of the route search packet in ST910.

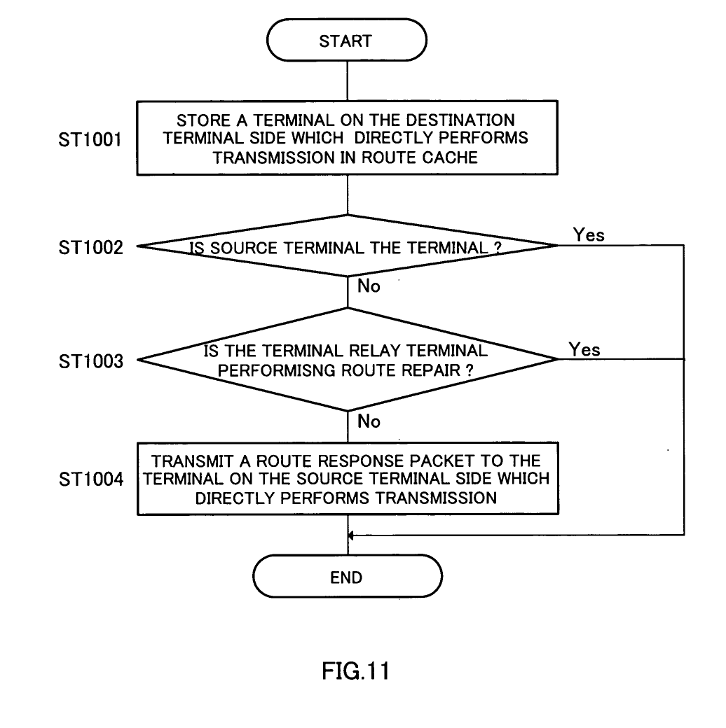

Next, detailed procedures of the reception processing of the route response packet shown in ST609 in FIG. 6 will be described using FIG. 11. In FIG. 11, in ST1001, a terminal stores another terminal, which transmits a route response packet on the destination terminal side to the terminal, as a terminal which directly performs transmission (here, destination terminal 212) in route cache 115.

In ST1002, by determining whether or not the terminal is a destination of the route response packet, namely, the source terminal (that is source terminal 211 by appearance although it is relay terminal 206 that actually transmits the route search packet) of the route search packet, the terminal determines whether or not to relay the route response packet. When the destination of the route response packet is the terminal (“Yes”), the terminal finishes a series of route establishing operations, and when the destination of the route response packet is not the terminal (“No”), the processing shifts to ST1003.

In ST1003, the terminal determines whether or not relay terminal 210 repairs a route from the terminal to destination terminal 212, and when the route is already repaired (“Yes”), the terminal finishes a series of route repair operations, and when the route is not repaired (“No”), processing shifts to ST1004. It is relay terminal 206 that determines that the route is repaired, and this relay terminal 206 receives the route response packet from destination terminal 212 through relay terminal 210 and repairs the route to destination terminal 212, so that the route repair operation is completed.

In ST1004, the terminal transmits the route response packet by unicast to a relay terminal on source terminal 211 side which directly performs transmission. The terminal determining that the route repair is not performed in ST1003 is relay terminal 210, and relay terminal 210 transmits the route response packet to relay terminal 206 by unicast.

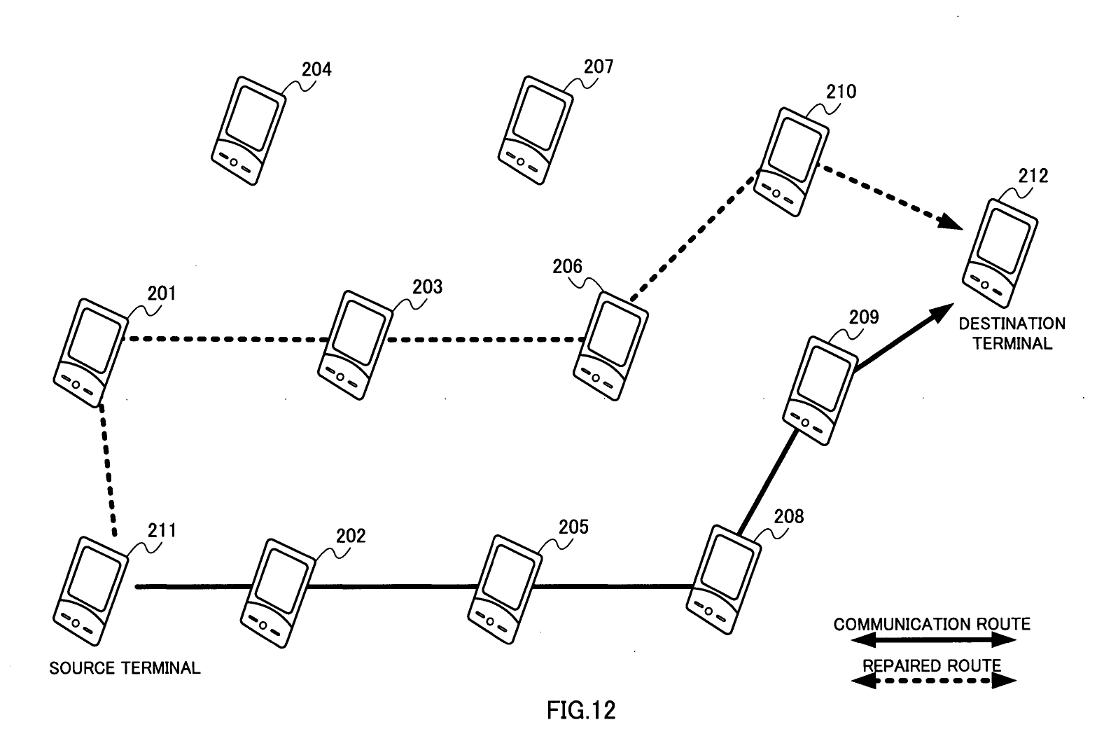

The route search packet transmitted from destination terminal 212 to source terminal 211 is propagated to source terminal 211 as the destination by executing the above-mentioned reception processing of the route search packet. The terminals receiving the route search packet (including route repair information) to source terminal 211 updates a route to destination terminal 212 in the processing of ST902 in FIG. 9, and when a packet first reaching source terminal 211 is relayed by relay terminals 209, 208, 205 and 202 in this order among the route search packets relayed from destination terminal 212 to source terminal 211 here, the route from source terminal 211 to destination terminal 212 is established by source terminal 211, relay terminals 202, 205, 208 and 209, and destination terminal 212, as shown in FIG. 12.

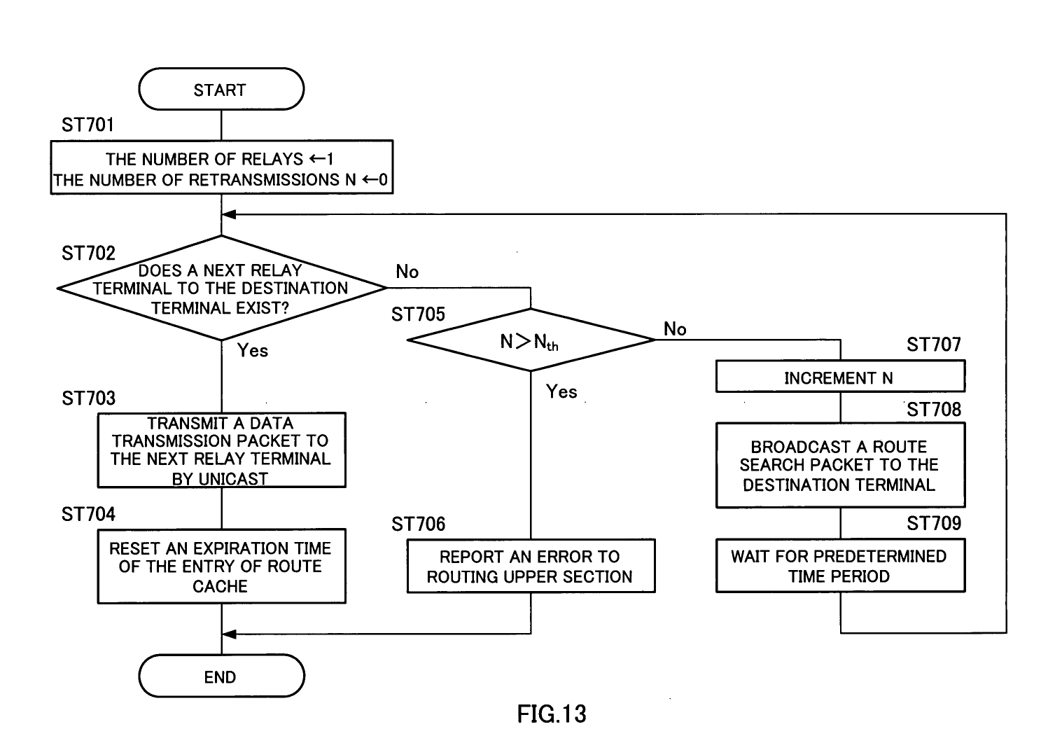

Next, detailed procedures of the reception processing of the data transmission packet shown in ST610 in FIG. 6 will be described using FIG. 13. In FIG. 13, in ST701, the number of relays of a data packet is set to “1”, and the number of retransmissions is cleared to “0.”

In ST702, a terminal determines whether or not a relay terminal on the destination terminal 212 side, to which the terminal directly performs transmission exists in route cache 115 of the terminal, and when such a terminal exists in route cache 115 (“Yes”), the processing shifts to ST703, and when the terminal does not exist in route cache 115 (“No”), the processing shifts to ST705.

In ST703, the terminal transmits a data transmission packet by unicast to the relay terminal determined to exist in cache 115 in ST702, resets the expiration time of an entry of the terminal determined to exist in route cache 115 in ST702, and finishes the reception processing of the data transmission packet in ST704.

When the terminal does not have a route to destination terminal 212, for example, immediately after joining the network, a relay terminal on the destination terminal 212 side which directly performs transmission is determined not to exist in route cache 115 of the terminal, and the processing shifts to the route establishment operation subsequent to ST705. In other words, in ST705 whether or not the number of retransmissions N exceeds a predetermined number (Nₜₕ) of times is determined, and when N exceeds the predetermined number, processing shifts to ST706, and when N does not exceed the predetermined number, the processing shifts to ST707.

In ST706, since the number of retransmissions N is determined to exceed the threshold Nₜₕ in ST705, the terminal reports an error indicating that routing of the received data transmission packet cannot be performed to routing upper section 116, and finishes the reception processing of the data transmission packet.

In ST707, the terminal increments the number of retransmissions N, and in ST708, broadcasts the route search packet to destination terminal 212.

In ST709, the terminal waits for a predetermined time period sufficient to complete the exchange of the route search packet and route response packet, and returns to ST702.

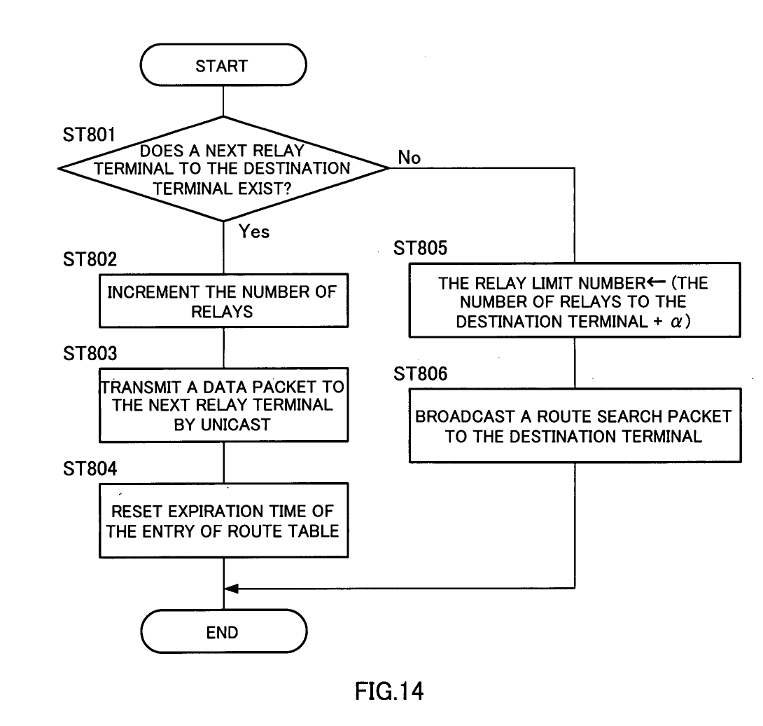

Next, detailed procedures of the reception processing of the data relay packet as shown in ST611 in FIG. 6 will be described using FIG. 14. In FIG. 14, in ST801, a terminal determines whether or not a relay terminal on the destination terminal 212 side, which directly performs transmission exists in route cache 115 of the terminal, and when such a terminal exists in route cache 115 (“Yes”), the processing shifts to ST802, and when such a terminal does not exist in route cache 115 (“No”), the processing shifts to ST805.

In the case that the route shown by the bold lines in FIG. 10 is established by the route repair operation by relay terminal 206, relay terminal 206 that finishes the route repair recognizes in determination of ST801 that relay terminal 210 is the relay terminal on the destination terminal 212 side, which directly performs transmission, so that relay terminal 206 increments the number of previous relay times in ST802, and in ST803, transmits data packets to destination terminal 212 stored in the buffer to relay terminal 210 as a subsequent relay terminal by unicast.

In ST804, for example, using a data transfer acknowledge response and the like in layer 2, when the terminal acknowledges that data transfer to relay terminal 210 is completed, the terminal updates the entry to the corresponding destination terminal stored in route cache 115 of the terminal.

Since the route to destination terminal 212 is already deleted and does not exist, a data packet to destination terminal 212 received from relay terminal 203 is stored in a transmission buffer. In ST805, the terminal sets the relay limit number of the route search packet at a value obtained by adding a predetermined number (herein, α that can be set arbitrarily) to the number of previous relays from relay terminal 206 to destination terminal 212, and in ST806, describes the content of the packet as if the packet were a route search packet from source terminal 211 to destination terminal 212, and broadcasts the route search packet (having a route search packet transmission request to source terminal 211) to destination terminal 212.

Thus, according to this embodiment, a relay terminal detecting communication disconnection makes requests for both route repair and transmission of a route search packet to a destination terminal, so that the relay terminal can repair the route to the destination terminal immediately without wasting data packets for the destination terminal stored in the relay terminal detecting the communication disconnection and reduce the time required to establish an optimal route from the source terminal to the destination terminal.

A first aspect of the present invention is a packet routing apparatus for establishing a route for packet transmission and transmitting packets from a source apparatus to a destination apparatus by radio signals using a plurality of apparatuses, the packet routing apparatus employing a configuration having: a reception section that receives a radio signal containing packets and detects that communication with a communication apparatus directly transmitting the packets using radio signals, is disconnected; a control section that determines whether the packet routing apparatus is located on a side of a destination wireless terminal apparatus or a side of a source wireless terminal apparatus of the packets; and a transmission section that broadcasts a request signal for route repair to a destination communication apparatus of the packets when communication with the communication apparatus directly transmitting the packets using radio signals is determined to be disconnected and the packet routing apparatus is determined to be located on the side of the source wireless terminal apparatus.

A second aspect of the invention is the packet routing apparatus wherein: the reception section receives a radio signal containing the request signal for route repair; the control section determines whether or not the request signal for route repair is for repairing a route to the packet routing apparatus; and when the request signal for route repair is for repairing the route to the packet routing apparatus, the transmission section broadcasts a request signal for route reestablishment to a source of the packets.

A third aspect of the invention is a packet routing apparatus further having a route cache section that stores the communication apparatus directly transmitting the packets using radio signals as a relay candidate, wherein, when communication with the communication apparatus directly transmitting the packets using radio signals is disconnected, the control section deletes a communication apparatus with which communication of the packet routing apparatus is disconnected from relay candidates in the route cache section, and, when the destination apparatus of the packets to relay is not stored in the route cache section, the control section determines that the routing apparatus is located on the side of the source wireless terminal apparatus.

According to these configurations, a relay terminal detecting route disconnection makes requests for both route repair and transmission of a route search packet to a destination terminal, so that the relay terminal can repair the route to the destination terminal immediately without wasting data packets for the destination terminal stored in the relay terminal detecting the route disconnection and reduce the time required to establish an optimal route from a source terminal to the destination terminal.

A fourth aspect of the invention is a packet routing method in a system where packets are transmitted to a destination wireless terminal via a plurality of wireless terminal apparatuses, wherein: a relay wireless terminal apparatus detects that communication with a wireless terminal apparatus directly transmitting packets using radio signals is disconnected; the wireless terminal apparatus detecting that communication is disconnected determines whether the wireless terminal apparatus is located on a side of a destination wireless terminal apparatus or a side of a source wireless terminal apparatus of the packets; the wireless terminal apparatus determining that the wireless terminal apparatus is located on the side of the source wireless terminal apparatus broadcasts a request signal for route repair to the destination wireless terminal apparatus of the packets; and when receiving the request signal for route repair, the destination wireless terminal apparatus of the packets broadcasts a request for route reestablishment to the source wireless terminal apparatus of the packets.

According to this method, a relay terminal detecting route disconnection makes requests for both route repair and transmission of a route search packet to a destination terminal, so that the relay terminal can repair the route to the destination terminal immediately without wasting data packets for the destination terminal stored in the relay terminal detecting the route disconnection and reduce the time required to establish an optimal route from the source terminal to the destination terminal.

The present application is based on Japanese Patent Application No. 2004-043563 filed on Feb. 19, 2004, the entire content of which is expressly incorporated by reference herein.

### INDUSTRIAL APPLICABILITY

The packet routing method and packet routing apparatus according to the present invention have an advantageous effect of reestablishing a route from a source terminal to a destination terminal immediately without wasting data packets for the destination terminal stored in a buffer of a relay terminal detecting communication disconnection upon reestablishing the route on a network, and are suitable for use in an adhoc network and the like where wireless terminal apparatuses communicate with one another.

1. A packet routing apparatus for establishing a route for packet transmission and transmitting packets from a source apparatus to a destination apparatus by radio signals using a plurality of apparatuses, the packet routing apparatus comprising:
a reception section that receives a radio signal containing packets and detects that communication with a communication apparatus directly transmitting the packets using radio signals, is disconnected;
a control section that determines whether the packet routing apparatus is located on a side of a destination wireless terminal apparatus or a side of a source wireless terminal apparatus of the packets; and
a transmission section that broadcasts a request signal for route repair to a destination communication apparatus of the packets when communication with the communication apparatus directly transmitting the packets using radio signals is determined to be disconnected and the packet routing apparatus is determined to be located on the side of the source wireless terminal apparatus.

2. The packet routing apparatus according to claim 1, wherein:
the reception section receives a radio signal containing the request signal for route repair;
the control section determines whether or not the request signal for route repair is for repairing a route to the packet routing apparatus; and
when the request signal for route repair is for repairing the route to the packet routing apparatus, the transmission section broadcasts a request signal for route reestablishment to a source of the packets.

3. The packet routing apparatus according to claim 1, further comprising a route cache section that stores the communication apparatus directly transmitting the packets using radio signals as a relay candidate,
wherein, when communication with the communication apparatus directly transmitting the packets using radio signals is disconnected, the control section deletes a communication apparatus with which communication of the packet routing apparatus is disconnected from relay candidates in the route cache section, and, when the destination apparatus of the packets to relay is not stored in the route cache section, the control section determines that the routing apparatus is located on the side of the source wireless terminal apparatus.

4. A packet routing method in a system where packets are transmitted to a destination wireless terminal via a plurality of wireless terminal apparatuses, wherein:
a relay wireless terminal apparatus detects that communication with a wireless terminal apparatus directly transmitting packets using radio signals is disconnected;
the wireless terminal apparatus detecting that communication is disconnected determines whether the wireless terminal apparatus is located on a side of a destination wireless terminal apparatus or a side of a source wireless terminal apparatus of the packets;
the wireless terminal apparatus determining that the wireless terminal apparatus is located on the side of the source wireless terminal apparatus broadcasts a request signal for route repair to the destination wireless terminal apparatus of the packets; and
when receiving the request signal for route repair, the destination wireless terminal apparatus of the packets broadcasts a request for route reestablishment to the source wireless terminal apparatus of the packets.
